(19) United States
(12) Patent Application Publication
(10) Pub. No.: US 2024/0265331 A1
(43) Pub. Date: Aug. 8, 2024

(54) MULTI-OBJECTIVE OPTIMIZATION BASED SERVICE POLICY GENERATION

(71) Applicant: Alipay (Hangzhou) Information Technology Co., Ltd., Hangzhou (CN)

(72) Inventors: Shiwei LIANG, Hangzhou (CN); Yin LOU, Sunnyvale, CA (US); Nan LI, Hangzhou (CN); Bai HUANG, Hangzhou (CN); Jiang QIAN, Hangzhou (CN); Fei XUE, Hangzhou (CN); Wanjing JIANG, Hangzhou (CN); Jiayue LI, Hangzhou (CN); Xirui LI, Hangzhou (CN)

(21) Appl. No.: 18/567,265

(22) PCT Filed: Jun. 30, 2022
(86) PCT No.: PCT/CN2022/102671

§ 371 Date: Dec. 5, 2023

(30) Foreign Application Priority Data
Jul. 28, 2021 (CN) 202110858293.7

(51) Int. Cl. G06Q 10/0639

(52) U.S. Cl. CPC G06Q 10/06393

(57) ABSTRACT

Embodiments of this specification provide a multi-objective learning-based service policy generation method and service policy generation apparatus. In the service policy generation method, a labeled service data sample set is obtained, where each piece of service data sample includes at least one service feature and at least two label values of the piece of service data sample; multi-objective optimization-based service rule training is performed based on the labeled service data sample set, to construct a service rule set, where each optimization objective in multi-objective optimization corresponds to one label in the service data; and then a service policy is generated based on the constructed service rule set.

### TECHNICAL FIELD

Embodiments of this specification usually relate to the field of service processing, and in particular, to a multi-objective optimization based service policy generation method and service policy generation apparatus, and a distributed service policy generation system.

### BACKGROUND

Service parties use various service policies during service processing. Conventional service policy generation is mostly determined by a policy expert based on manual experience. However, the manual experience of the policy expert requires long-term accumulation and learning, and the manual experience is sometimes unreliable. As services rapidly develop, efficient and reliable service policy generation becomes an urgent problem to be resolved.

### SUMMARY

In view of the foregoing, embodiments of this specification provide a multi-objective optimization-based service policy generation method and service policy generation apparatus, and a distributed service policy generation system. A service policy can be efficiently and reliably generated by using the service policy generation method and apparatus.

According to an aspect of the embodiments of this specification, a multi-objective learning-based service policy generation method is provided, and includes: obtaining a service data sample set, where each service data sample in the service data sample set includes at least one service feature and at least two label values; performing multi-objective optimization-based service rule training based on the service data sample set, to construct a service rule set, where each optimization objective in multi-objective optimization corresponds to one label in the service data; and generating a service policy based on the service rule set.

Optionally, in an example of the aspect, the performing multi-objective optimization-based service rule training based on the service data sample set, to construct a service rule set can include: performing multi-objective optimization-based service rule training based on the service data sample set by using a sequential covering algorithm, to construct the service rule set.

Optionally, in an example of the aspect, an evaluation indicator used for the multi-objective optimization is determined based on optimization objectives corresponding to the labels in the service data sample.

Optionally, in an example of the aspect, the at least two labels include a black sample label and a capital loss label, and the optimization objectives include a black sample hit precision rate corresponding to the black sample label and a capital loss recall rate corresponding to the capital loss label.

Optionally, in an example of the aspect, the evaluation indicator node_score is determined based on the following formula:

$$nod\_score = ( 1 + {β}^{2} ) * \frac{precision * {recall}_{captial \_ loss}}{{β}^{2} * precision + {recall}_{captial \_ loss}} ,$$

where
precision represents the black sample hit precision rate, recall_{capital_loss} represents the capital loss recall rate, and β is a hyper-parameter used to adjust weights of two optimization objectives.

Optionally, in an example of the aspect, the service data sample set used for the service rule training is a service data sample set obtained after feature selection processing.

Optionally, in an example of the aspect, the service policy generation method can further include: performing feature preprocessing on the obtained service data sample set before the service rule set is constructed.

Optionally, in an example of the aspect, the feature preprocessing includes at least one of the following preprocessing: feature selection processing, monotonicity constraint processing, and feature physical meaning constraint processing.

Optionally, in an example of the aspect, the service policy generation method can further include: performing rule optimization on the constructed service rule set.

Optionally, in an example of the aspect, the rule optimization includes at least one of the following optimization processing: rule deduplication, specific service constraint-based rule filtering, reverse rule supplementation, visualization-based manual filtering, and custom indicator-based rule filtering.

Optionally, in an example of the aspect, the generating a service policy based on the service rule set can include: generating the service policy based on the service rule set by using a greedy algorithm.

Optionally, in an example of the aspect, the service policy generation method can further include: performing inverted tree result visualization processing on the generated service policy; and/or providing a visual evaluation report to a service party during service generation or policy generation.

Optionally, in an example of the aspect, the service policy generation method can further include: performing policy evaluation on the generated service policy; and providing the service policy whose policy evaluation succeeds to a service party.

Optionally, in an example of the aspect, the obtaining a service data sample set can include: obtaining the service data sample set and a specified service constraint; and the performing multi-objective optimization-based service rule training based on the service data sample set, to construct a service rule set can include: performing multi-objective optimization-based service rule training based on the service data sample set and the specified service constraint, to construct the service rule set.

According to another aspect of the embodiments of this specification, a multi-objective learning-based service policy generation apparatus is provided, and includes: a data obtaining unit, configured to obtain a service data sample set, where each service data sample in the service data sample set includes at least one service feature and at least two label values; a rule training unit, configured to perform multi-objective optimization-based service rule training based on the service data sample set, to construct a service rule set, where each optimization objective in multi-objective optimization corresponds to one label in the service data sample; and a policy generation unit, configured to generate a service policy based on the service rule set.

Optionally, in an example of the aspect, the rule training unit performs multi-objective optimization-based service rule training based on the service data sample set by using a sequential covering algorithm, to construct the service rule set.

Optionally, in an example of the aspect, the service policy generation apparatus can further include a feature preprocessing unit, configured to perform feature preprocessing on the obtained service data sample set before the service rule set is constructed.

Optionally, in an example of the aspect, the service policy generation apparatus can further include a rule optimization unit, configured to perform rule optimization on the constructed service rule set.

Optionally, in an example of the aspect, the service policy generation apparatus can further include a visualization processing unit, configured to perform inverted tree result visualization processing on the generated service policy.

Optionally, in an example of the aspect, during service generation or policy generation, the visualization processing unit further provides a visual evaluation report to a service party.

According to another aspect of the embodiments of this specification, a distributed service policy generation system is provided, and includes: at least two first member devices, where each first member device includes the service policy generation apparatus described above; and a second member device, configured to schedule service data sample distribution between the first member devices.

According to another aspect of the embodiments of this specification, a multi-objective learning-based service policy generation apparatus is provided, and includes at least one processor, a storage coupled to the at least one processor, and a computer program stored in the storage. The at least one processor executes the computer program to implement the service policy generation method described above.

According to another aspect of the embodiments of this specification, a computer-readable storage medium is provided. The computer-readable storage medium stores executable instructions. When the instructions are executed, a processor is enabled to perform the service policy generation method described above.

According to another aspect of the embodiments of this specification, a computer program product is provided, and includes a computer program. The computer program is executed by a processor to implement the service policy generation method described above.

### BRIEF DESCRIPTION OF DRAWINGS

The essence and advantages of the content of this specification can be further understood with reference to the following accompanying drawings. In the accompanying drawings, similar components or features can have the same reference numerals.

FIG. 1 is an example flowchart of a service policy generation method according to Embodiment 1 of this specification;

FIG. 2 is an example schematic diagram of a service data set according to Embodiment 1 of this specification;

FIG. 3 is an example flowchart of a service rule training process based on a sequential covering algorithm according to Embodiment 1 of this specification;

FIG. 4 is an example block diagram of a service policy generation apparatus according to Embodiment 1 of this specification;

FIG. 5 is an example flowchart of a service policy generation method according to Embodiment 2 of this specification;

FIG. 6 is an example schematic diagram of inverted tree result visualization processing for a service policy according to Embodiment 2 of this specification;

FIG. 7 is an example schematic diagram of a visual evaluation report according to Embodiment 2 of this specification;

FIG. 8 is an example schematic diagram of a service policy generation process according to Embodiment 2 of this specification;

FIG. 9 is an example block diagram of a service policy generation apparatus according to Embodiment 2 of this specification;

FIG. 10 is an example block diagram of a distributed service policy generation system according to Embodiment 3 of this specification; and

FIG. 11 is an example schematic diagram of a service policy generation apparatus implemented based on a computer system according to an embodiment of this specification.

### DESCRIPTION OF EMBODIMENTS

The subject matter described in this specification is described here with reference to example implementations. It should be understood that these implementations are described only to enable a person skilled in the art to better understand and implement the subject matter described in this specification, and are not intended to limit the protection scope, applicability, or examples described in the claims. The functions and arrangements of the described elements can be changed without departing from the protection scope of the content of this specification. Based on a requirement, the examples can be omitted or replaced, or various processes or components can be added. For example, the described method can be performed in a sequence different from the described sequence, and the steps can be added, omitted, or combined. In addition, features described relative to some examples can be combined in other examples.

As used in this specification, the term “including” and variants thereof represent open terms, and mean “including but not limited to”. The term “based on” means “at least partially based on”. The terms “one embodiment” and “an embodiment” mean “at least one embodiment”. The term “another embodiment” means “at least one other embodiment”. The terms “first”, “second”, and the like can refer to different or the same objects. Other definitions can be included below, either explicitly or implicitly. Unless explicitly stated in the context, the definition of a term is consistent throughout the specification.

In this specification, the term “service rule” includes a series of unordered conditions (condition). A condition can be defined as [x op v], where x is a feature, v is a value in the eigenvalue range, and op represents an operator. For example, op can be one of “<”, “≥”, “=”, “!=”, “∈”, and “∉”. For example, “a<12 and b>7 and c=‘X’” can represent a service rule, where a, b, and c represent service features. The term “service policy” represents a combination of a plurality of service rules. For example, the service policy can be a combination of a predetermined quantity of service rules.

The multi-objective optimization-based service policy generation method and service policy generation apparatus, and the distributed service policy generation system according to the embodiments of this specification are described in detail below with reference to the accompanying drawings.

### Embodiment 1

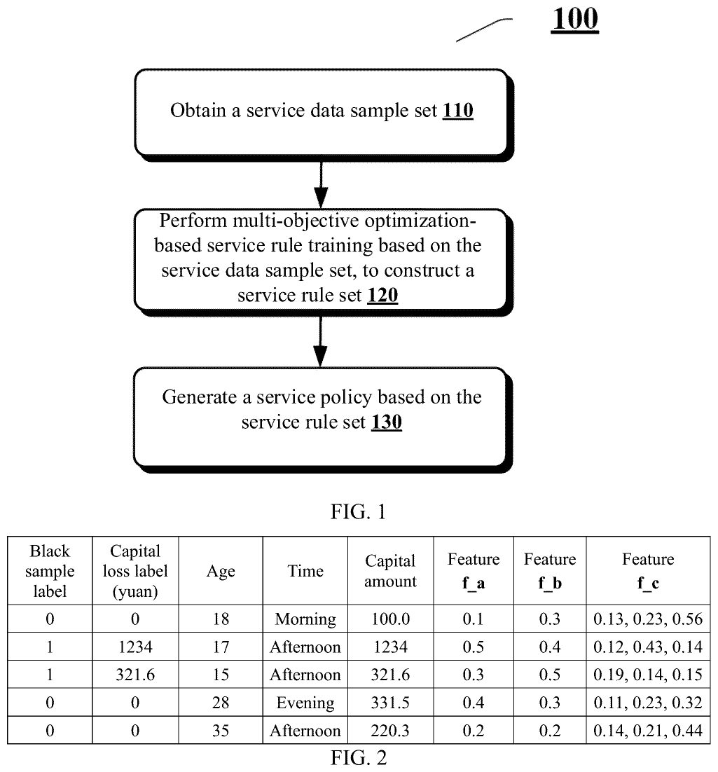

FIG. 1 is an example flowchart of a service policy generation method 100 according to Embodiment 1 of this specification. The service policy generation method is performed by a service policy generation apparatus. The service policy generation apparatus can be deployed, for example, on a policy provider.

As shown in FIG. 1, in 110, a service data sample set is obtained. Each service data sample in the obtained service data sample set is a labeled service data sample, and is used to train a service rule. For example, the service data sample set can be labeled form data. In this specification, each service data sample can include at least one service feature and at least two label values. Each of the at least two labels in the service data sample corresponds to one optimization objective. Here, for example, the service data sample set can be a service data sample collected and labeled by a service party, and is provided by the service party to the service policy generation apparatus. For example, the service party can provide the service data sample set to the service policy generation apparatus through an input interface of the service policy generation apparatus. For example, the input interface can be an input interface on the service policy generation apparatus or a communication interface on the service policy generation apparatus.

FIG. 2 is an example schematic diagram of a service data set according to Embodiment 1 of this specification. The service data set shown in FIG. 2 is labeled form data. The form data shown in FIG. 2 includes two labels: a first column “black sample label” and a second column “capital loss label”. The “black sample label” is used to indicate that the service data sample is a risky service data sample, for example, a service data sample with a fraud behavior. The “capital loss label” is used to indicate capital loss data caused by the service data sample. In addition, the form data shown in FIG. 2 further includes six service features, namely, service features represented by a third column “age” to a sixth column “f_c”. In the service features, a service feature represented by “age” is a user age, a service feature represented by “time” is an occurrence time of the service data sample, a service feature represented by “capital amount” is a capital amount in the service data sample, a service feature represented by f_a is a three-day click on a page a (a value obtained after standardization processing), a service feature represented by f_b is a three-day click on a page b (a value obtained after standardization processing), and a service feature represented by “f_c” is a three-dimensional embedding feature. The first five service features are interpretable, and the service feature f_c is not interpretable.

In 120, multi-objective optimization-based service rule training is performed based on the service data sample set, to construct a service rule set. In this specification, the term “multi-objective optimization” means to simultaneously make two or more optimization objectives as optimal as possible in a given region. In an example, the optimization objective can be set by the service party. Each optimization objective in the multi-objective optimization corresponds to one label in the service data sample. Optionally, in an example, an evaluation indicator used for the multi-objective optimization can be determined based on optimization objectives corresponding to the labels in the service data sample.

For example, in an example of an anti-fraud application scenario, the at least two labels in the service data sample can include a black sample label and a capital loss label. Here, a value of the black sample label is 0 or 1. When the value of the black sample label is 0, the service data sample is not a fraud sample. When the value of the black sample label is 1, the service data sample is a fraud sample. A value of the capital loss label is a real number greater than or equal to 0, and the value of the capital loss label is a capital amount in the service data sample. Correspondingly, the optimization objectives in the multi-objective optimization can include a black sample hit precision rate corresponding to the black sample label and a capital loss recall rate corresponding to the capital loss label.

In this case, in an example, the evaluation indicator node_score used for the multi-objective optimization can be determined based on, for example, the following formula:

$$nod\_score = ( 1 + {β}^{2} ) * \frac{precision * {recall}_{captial \_ loss}}{{β}^{2} * precision + {recall}_{captial \_ loss}} .$$

Here, precision represents the black sample hit precision rate, recall_{captial_loss} represents the capital loss recall rate, and β is a hyper-parameter used to adjust weights of two optimization objectives.

Optionally, in an example, multi-objective optimization-based service rule training can be performed based on the obtained service data sample set by using a sequential covering algorithm, to construct the service rule set. For example, an example of the sequential covering algorithm can include but is not limited to a LightGBM-based sequential covering (Tree_based sequential covering) algorithm.

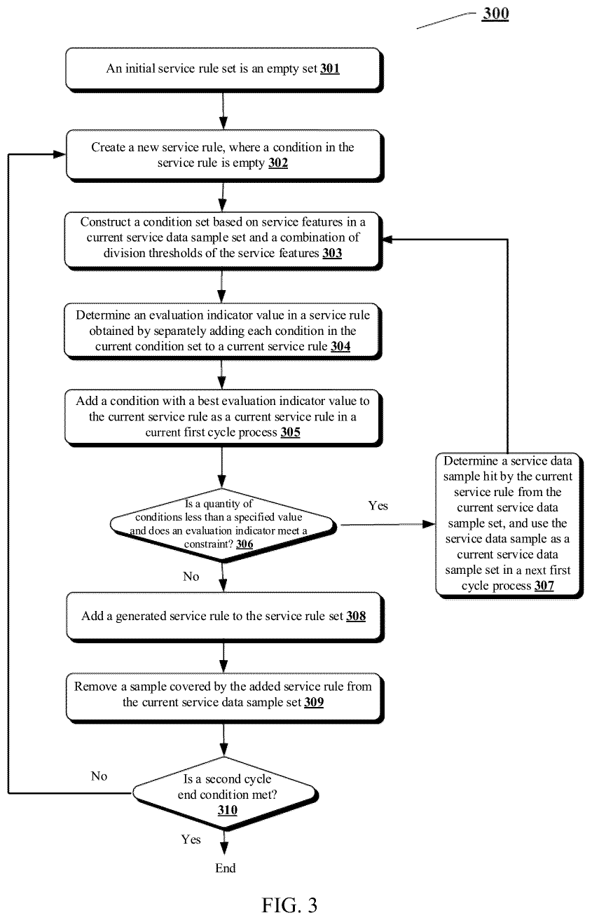

FIG. 3 is an example flowchart of a service rule training process 300 based on a sequential covering algorithm according to Embodiment 1 of this specification.

As shown in FIG. 3, in 301, an initial service rule set is created, and the initial service rule set is an empty set. Then, operations in 302 to 310 are cyclically performed until a cycle end condition (namely, a second cycle end condition in FIG. 3) is met. In this specification, the cycle end condition can include that all positive samples in the service data sample set are removed or a quantity of service rules in the service rule set reaches a specified value. Here, the positive sample is a service data sample that conforms to a service rule constructed based on the service data sample. In each cycle process, a single service rule is constructed based on a current service data sample set. In a first cycle process, the current service data sample set is the obtained service data sample set. In a subsequent cycle process, the current service data sample set is a service data sample set obtained by removing a positive sample that conforms to a currently constructed service rule from a current service data sample set used in a previous cycle process. In the service rule training process in FIG. 3, there are two cycle processes: a first cycle process from 303 to 307 and a second cycle process from 302 to 310. The first cycle process is used to construct a single service rule, and the second cycle process is used to construct a service rule set.

Specifically, in 302, a new service rule is created, and a condition (Condition) in the created new service rule is empty. Then, the first cycle process from 303 to 307 is cyclically performed, and a condition is added to the created new service rule. In each first cycle process, in 303, a condition set is constructed based on service features in the current service data sample set and a combination of division thresholds of the service features. For example, it is assumed that the service features in the current service data sample set include a service feature X1 and a service feature X2, feature values of the service feature X1 are k1 to k3, and feature values of the service feature X2 are k4 and k5. During construction of a condition set, division thresholds of the service features X1 and X2 are first determined. When the service feature is a categorical service feature, the division threshold of the service feature is the feature value of the service feature. When the service feature is a continuous service feature, a binning operation (for example, equal-frequency or equal-width binning) is performed on the service feature, and a boundary value of each bin is the division threshold of the service feature. After the division thresholds of the service features are obtained, a condition set is constructed based on the service features and a combination of the division thresholds of the service features. For example, if division thresholds of the service feature X1 are k1, k2, and k3, and division thresholds of the service feature X2 are k4 and k5, where K1<k2<k3, and k4<k5, a condition (Condition) set can be constructed. The constructed condition set includes, for example, various combinations of the following conditions: X1≤k1, k1<X1≤k2, k2<X1≤k3, X1>k3, X2≤k4, k4<X2≤k5, and X2>k5.

In 304, an evaluation indicator value, for example, node_score, in each new service rule obtained by adding each condition in the constructed condition set to a current service rule (namely, a service rule obtained in a previous first cycle process) is determined. Specifically, service processing, for example, black sample prediction processing shown in FIG. 2, is performed by using the new service rule. Then, a corresponding evaluation indicator value is determined by using a service processing result. The data in FIG. 2 is used as an example. It is assumed that there is a rule “age≤18”, the rule hits a first sample and a second sample, precision in the rule is equal to ½-0.5, and capital loss recall=1234/(1234+321.6)=0.7933, and it is assumed that B is 0.1. In this case, node_score=(1+0.1*0.1)*(0.5*0.7933)/(0.1*0.1*0.5+0.7933)=0.5018.

As described above, after the evaluation indicator value in each new service rule is obtained, in 305, a condition with a best evaluation indicator value is added to the current service rule as a service rule obtained in a current first cycle process. For example, in the constructed condition set corresponding to the service feature X1, if an evaluation indicator value in a new service rule obtained by adding X1≤k1 is the best, X1≤k1 is added to the current service rule as the service rule obtained in the current first cycle process.

In 306, it is determined whether a quantity of conditions in the service rule obtained in the current first cycle process is less than a specified value, and an evaluation indicator in the service rule obtained in the current first cycle process meets a service constraint value. Here, the service constraint value can be a service constraint value set by a rule constructor based on a service application scenario, or a service constraint value provided by the service party. If it is determined, in 306, that the quantity of conditions in the service rule obtained in the current first cycle process is less than the specified value and the evaluation indicator in the service rule obtained in the current first cycle process meets the service constraint value, in 307, a service data sample hit by the current service rule is determined from the current service data sample set, and is used as a current service data sample set in a next first cycle process, and then 303 is performed again to perform the next first cycle process.

If it is determined, in 306, that the quantity of conditions in the service rule obtained in the current first cycle process is not less than the specified value or the evaluation indicator in the service rule obtained in the current first cycle process does not meet the service constraint value, the process proceeds to 308 to add the generated service rule (namely, the service rule obtained in the current first cycle process) to a service rule set obtained in a previous second cycle process.

In 309, a service data sample covered by the added service rule, namely, a positive sample that conforms to the added service rule, is removed from the current service data sample set. Then, in 310, it is determined whether a cycle end condition is met. Here, the cycle end condition is a cycle end condition used to end the second cycle process. The cycle end condition of the second cycle process can include that all positive samples in the service data sample set are removed or a quantity of service rules in the service rule set reaches a specified value.

If it is determined, in 310, that the cycle end condition is met, the service rule training process is completed, and the service rule set is constructed. If it is determined, in 310, that the cycle end condition is not met, the process returns to 302 to perform a next second cycle process. The foregoing process is cyclically performed, to construct the service rule set.

To more clearly describe the first cycle process, the first cycle process is described below by using the service data sample set shown in FIG. 2 as an example. It is preset that a quantity of conditions in the service rule is not greater than 3. In a first round of cycle, an initial condition in the service rule is empty. A condition set in the first round of cycle is constructed based on five samples. If a condition selected in the first round of cycle is “age≤20”, a quantity of conditions obtained after the first round of cycle is 1, that is, “age≤20”. Then, a second round of cycle is started. When the second round of cycle is started, the service rule is “age≤20”, and a service data sample hit based on the service rule is a first service data sample, a second service data sample, and a third service data sample. In the second round of cycle, a condition set in the second round of cycle is constructed based on the first sample, the second sample, and the third sample. If a condition selected in the second round of cycle is “time-afternoon”, a quantity of conditions in the service rule obtained in the second round of cycle is 2, that is, “age≤20” and “time=afternoon”. Then, a third round of cycle is started. Similarly, when the third round of cycle is started, the service rule is “age≤20” and “time=afternoon”, and the second service data sample and the third service data sample are hit based on the service rule. In the third round of cycle, a condition set in the third round of cycle is constructed based on the second service data sample and the third service data sample. If a condition selected in the third round of cycle is “amount>1000”, a quantity of conditions in the service rule obtained in the third round of cycle is 3, that is, “age≤20”, “time=afternoon”, and “amount>1000”. The first cycle end condition is met, and therefore the first cycle process ends.

It should be noted that the service rule generated according to this embodiment of this specification is a service rule generated by performing threshold division and combination on service features. For example, “a<12 and b>7 and c=′X” can represent a service rule, where a, b, and c represent service features, and 12, 7, and X respectively represent feature thresholds.

As described above, after the service rule set is constructed, the method returns to FIG. 1. In 130, a service policy is generated based on the constructed service rule set.

In an example, a predetermined quantity of service rules can be randomly extracted from the constructed service rule set, to generate the service policy. Alternatively, in another example, a predetermined quantity of service rules can be selected from the constructed service rule set based on a service constraint, to generate the service policy.

Optionally, in an example, the service policy can be generated based on the constructed service rule set by using a greedy algorithm.

For example, it is assumed that 100 service rules are constructed in a service rule construction process, and the service policy is defined as a combination that includes 10 service rules. In a service policy generation process, first, the 100 service rules are traversed, the 100 service rules are evaluated based on a predefined evaluation indicator (for example, node_score described above), and a service rule with a best evaluation indicator is placed in the service policy as a first service rule in the service policy. Then, for 99 service rules obtained after the placed service rule is removed, the 99 service rules are traversed, a service policy including each of the 99 service rules and the first service rule is evaluated based on the predefined evaluation indicator, and a service rule corresponding to a service policy with a best evaluation indicator is placed in the service policy, to obtain a second service rule. This cycle is repeated until 10 service rules are obtained, and the service policy is generated.

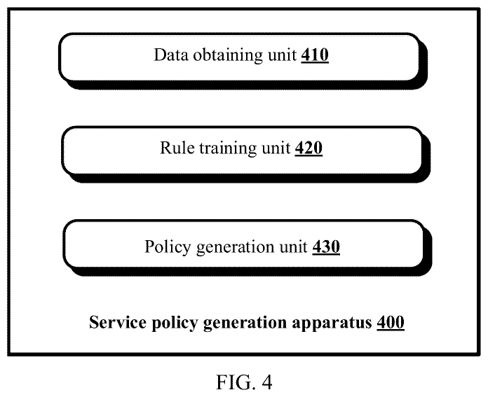

FIG. 4 is an example block diagram of a service policy generation apparatus 400 according to Embodiment 1 of this specification. As shown in FIG. 4, the service policy generation apparatus 400 includes a data obtaining unit 410, a rule training unit 420, and a policy generation unit 430.

The data obtaining unit 410 is configured to obtain a service data sample set. Each service data sample in the service data sample set includes at least one service feature and at least two label values. For an operation performed by the data obtaining unit 410, refer to the operation described above with reference to 110 in FIG. 1.

The rule training unit 420 is configured to perform multi-objective optimization-based service rule training based on the service data sample set, to construct a service rule set. Each optimization objective in multi-objective optimization corresponds to one label in the service data sample. For an operation performed by the rule training unit 420, refer to the operation described above with reference to 120 in FIG. 1.

The policy generation unit 430 is configured to generate a service policy based on the service rule set.

In an example, the rule training unit 420 can perform multi-objective optimization-based service rule training based on the service data sample set by using a sequential covering algorithm, to construct the service rule set. In another example, the rule training unit 420 can use another appropriate rule generation method to construct the service rule set.

In an example, the policy generation unit 430 can generate the service policy based on the service rule set by using a greedy algorithm.

In the foregoing service policy generation solution, the service policy can be automatically generated based on, for example, a plurality of optimization objectives provided by a service party and a labeled service data sample set, to implement efficient and reliable service policy generation. In addition, when the optimization objective is set by the service party, an evaluation indicator based on a service party side is used as an optimization objective in a service rule training process, to improve accuracy of the generated service policy.

In addition, optionally, in an example, the service data sample set used when the service rule training is performed in 120 can be a service data sample set obtained after feature selection processing. Specifically, some features can be selected from the obtained service data sample set as a service feature set used during subsequent service rule training. In an example, a service feature that is not interpretable or a service feature that is not highly interpretable, for example, some embedding features, can be filtered out from the service data sample. For example, for the service data sample shown in FIG. 2, the service feature f_c can be deleted. In another example, a service feature that does not meet a service scenario requirement can be filtered out. The feature selection processing on the service data sample set can be implemented on the service party side, or can be implemented on a policy generator side.

The feature selection processing is performed to filter out the service feature that does not meet the service scenario requirement or the service feature that is not interpretable in advance, so that a calculation amount can be reduced, training efficiency can be improved, and interpretability of the service rule can be enhanced.

### Embodiment 2

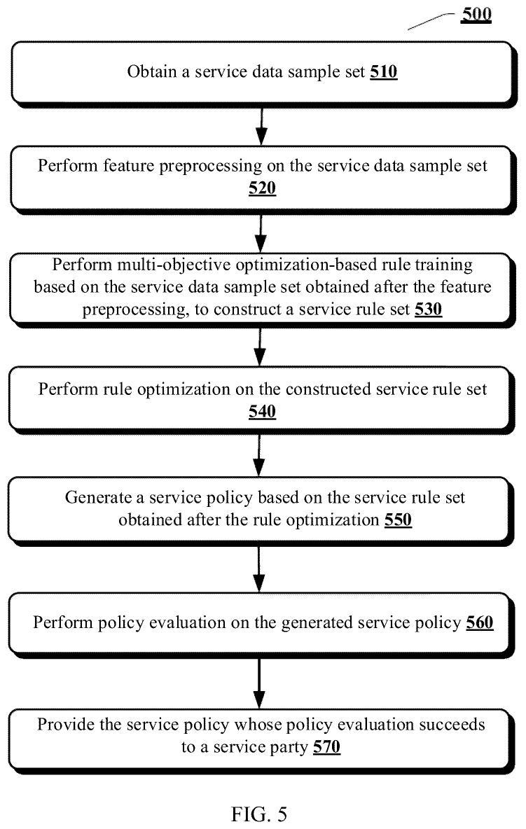

FIG. 5 is an example flowchart of a service policy generation method 500 according to Embodiment 2 of this specification. The embodiment of the service policy generation method shown in FIG. 5 is a modification to the embodiment of the service policy generation method shown in FIG. 1.

As shown in FIG. 5, in 510, a service data sample set is obtained. Optionally, a specified service constraint can be further obtained. Each service data sample in the obtained service data sample set is a labeled service data sample. Each service data sample can include at least one service feature and at least two label values. Each of the at least two labels in the service data sample corresponds to one optimization objective. The specified service constraint is a constraint condition specified when a service party performs service processing. For example, an example of the specified service constraint can include but is not limited to that a black sample hit precision rate is not less than M %, where M is a real number value greater than 0, a capital loss value should not be less than N yuan, and/or a user age cannot be less than 15 years.

In 520, feature preprocessing is performed on the obtained service data sample set. An example of the feature preprocessing can include but is not limited to feature selection processing, monotonicity constraint processing, and/or feature physical meaning constraint processing.

The feature selection processing on the service data sample set can be implemented in a manner the same as that described in Embodiment 1.

For some service features in the service data sample, only one not both of greater than/equal to or less than/equal to appear in a condition in a service rule. For example, the feature “predicted risk level of a model A” has a total of five levels: 1 to 5, where 1 indicates a lowest risk, and 5 indicates a highest risk. A rule in a fraud scenario is to identify a fraud case, only greater than/equal to can appear in the service rule for the service feature. Monotonicity constraint processing on a service feature is to constrain monotonicity of the service feature in a service rule. After monotonicity constraint is performed on the service feature, only constrained monotonicity can be presented for the service feature in the constructed service rule.

Feature physical meaning constraint means to enable a feature division threshold used in a service rule to be a value that appears in the service data sample, so that a constructed condition has better interpretability. For example, a division threshold of the service feature “age” can be an integer such as 18, 19, or 20, and is not a decimal number such as 18.5 or 19.5.

After the feature preprocessing is performed on the service data sample set, in 530, multi-objective optimization-based rule training is performed based on the service data sample set obtained after the feature preprocessing and the specified service constraint, to construct a service rule set. An operation in 530 is similar to the operation described above with reference to 120 in FIG. 2 and the operation described above with reference to FIG. 3. A difference lies in that in the operation in 530, the specified service constraint is considered when a condition of the service feature is constructed. For example, if the specified service constraint includes that the user age cannot be less than 15 years, when the condition of the service feature is constructed, a condition used to indicate that the user age is less than 15 years cannot be constructed.

In addition, when the service rule set is constructed in 530 by using the operation described in FIG. 3, a service constraint value in a first cycle end condition is the specified service constraint or a service constraint value determined based on the specified service constraint. For example, when the specified service constraint includes that the black sample hit precision rate is not less than M % and the capital loss value should not be less than N yuan, the service constraint value can be an evaluation indicator value determined based on the specified service constraint. In addition, in addition to the cycle end condition specified in FIG. 3, a second cycle end condition can further include that an evaluation indicator in a service rule is less than a specified value.

As described above, after the service rule set is constructed, in 540, rule optimization is performed on the constructed service rule set. An example of the rule optimization can include but is not limited to rule deduplication processing, specific service constraint-based rule filtering, reverse rule supplementation, visualization-based manual filtering, and/or custom indicator-based rule filtering.

The rule deduplication processing means to remove a duplicate service rule from the generated service rule. The specific service constraint-based rule filtering means to filter out a service rule that does not meet a specific service constraint from the generated service rule. For example, if for a service, it is required that some service rules are only for underage users, a service rule in which an age feature is greater than 18 is filtered out from these service rules. The reverse rule supplementation means to add a service rule used to determine a white sample to the generated service rule set. A reverse rule can be obtained through training by reversing black and white labels in the service data sample. The visualization-based manual filtering means to manually filter out an inappropriate service rule based on experience after the generated service rule is visualized. The custom indicator-based rule filtering means to perform rule filtering on the generated service rule based on a custom indicator of the service party. For example, if the service party requires that a per capita capital loss in the service rule is not less than X, the custom indicator is set to sum(loss)/count≥X, and rule filtering is performed by using the custom indicator.

After the rule optimization is performed on the constructed service rule set, in 550, a service policy is generated based on the service rule set obtained after the rule optimization. For a service policy generation process in 550, refer to the service policy generation process in 130 described above with reference to FIG. 1.

After the service policy is generated, in 560, policy evaluation is performed on the generated service policy. The policy evaluation can include evaluating the generated service policy based on a custom evaluation indicator. If a custom evaluation indicator value is reached, the policy evaluation succeeds. After the policy evaluation succeeds, in 570, the generated service policy is provided to the service party for subsequent service processing by the service party. If the policy evaluation fails, the service policy is discarded.

According to the service policy generation method provided in Embodiment 2, the feature preprocessing is performed on the obtained service data sample set, so that the generated service rule can be more suitable for a service requirement, to improve interpretability of the service rule and/or avoid a deviation caused by missing value filling.

According to the service policy generation method provided in Embodiment 2, the rule optimization is performed on the constructed service rule set, so that the generated service policy can be more accurate.

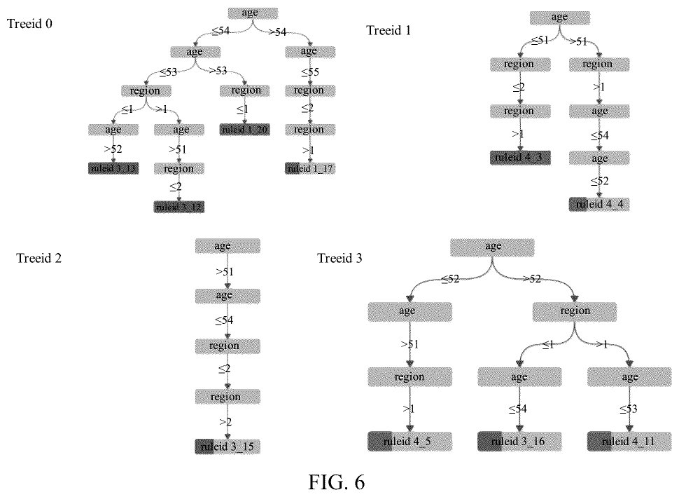

In addition, optionally, in some embodiments, after the service policy is generated, inverted tree result visualization processing can further be performed on the generated service policy. Some service features and division thresholds that have a distinction appear in a plurality of service rules. When visualization processing is performed on the service rule, these same service features and division thresholds can be used as common parent nodes, and the service rule is displayed in a tree form. FIG. 6 is an example schematic diagram of inverted tree result visualization processing for a service policy according to Embodiment 2 of this specification. In the visualization processing shown in FIG. 6, four trees including 10 service rules are displayed. An inverted tree visualization form of the service policy is used, so that the service party can intuitively obtain an approximate relationship between service rules.

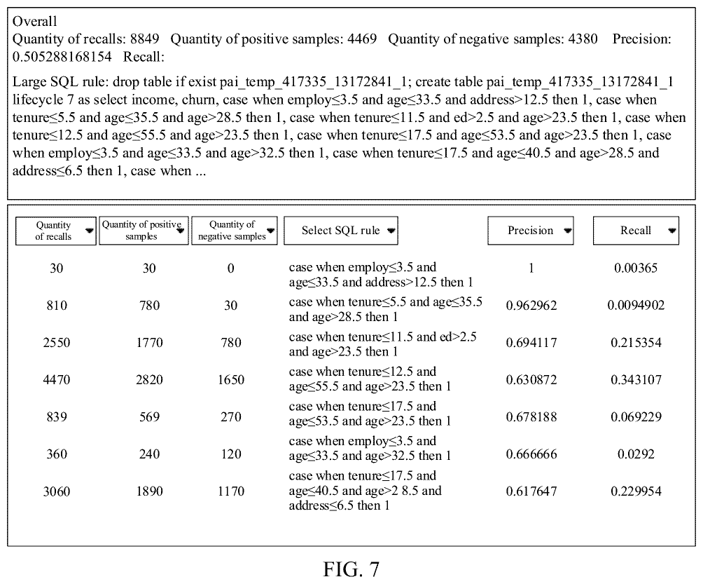

In addition, optionally, in some embodiments, during service rule generation or service policy generation, a visual evaluation report can further be provided to the service party. For example, for the generated service rule or service policy, or even an intermediate processing result, a visual evaluation report can be generated and provided to the service party for viewing. The visual evaluation report can include, for example, precision and recall of the service rule/service policy on a training set and a test set, a quantity of covered positive samples and a quantity of covered negative samples, and a custom indicator of the service party. FIG. 7 is an example schematic diagram of a visual evaluation report according to Embodiment 2 of this specification. In addition, optionally, the visual evaluation report shown in FIG. 7 can be presented in another appropriate visual form, for example, presented in a form of a visual graph.

In addition, optionally, in some embodiments, after the generated service policy is provided to the service party, policy management and policy monitoring can further be performed. The policy management can include, for example, generation of policy version management information and intelligent comparison between new and old policies. The policy monitoring can include intelligent abnormality warning and intelligent decline monitoring. The intelligent abnormality warning means to send warning information to the service party when a type of abnormality occurs frequently. The intelligent decline monitoring means to monitor whether a currently used service policy shows an effect decline sign. If an effect decline is shown, a policy effect decline alarm is sent to the service party, to remind the service party to regenerate a new service policy. The policy management can further include information push, for example, iterative recommendation push, evaluation report push, and effect warning push.

In addition, it should be noted that in another embodiment, some steps, for example, feature preprocessing, rule optimization, policy evaluation, and policy providing, in the service policy generation process shown in FIG. 5 may not be included.

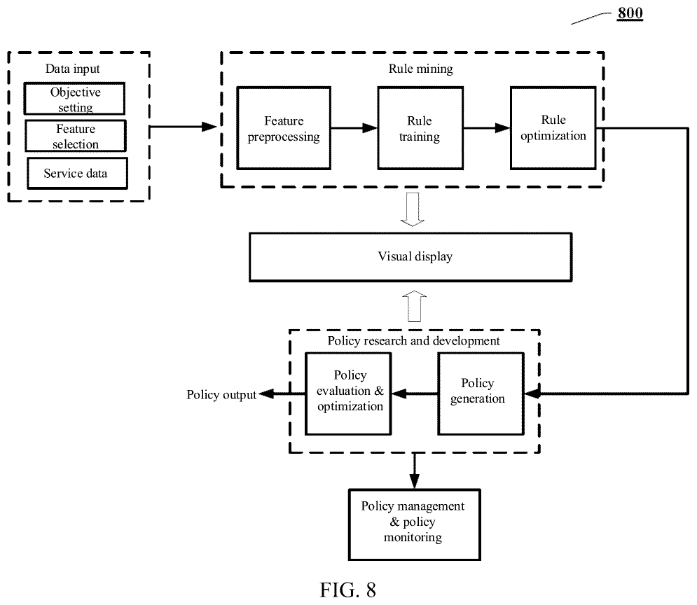

FIG. 8 is an example schematic diagram of a service policy generation process 800 according to Embodiment 2 of this specification.

As shown in FIG. 8, a service party inputs an optimization objective through objective setting, performs feature selection on a service feature in a service data sample, and provides a service data sample set obtained after the feature selection to a service policy generation apparatus at a service policy generator. In addition, optionally, the service party can further input a specified service constraint.

After the service data sample set is obtained, the service policy generation apparatus performs feature preprocessing on the service data sample, and performs multi-objective optimization-based rule training based on the service data sample set obtained after the feature preprocessing, to construct a service rule set. After the service rule set is constructed, rule optimization is performed on the constructed service rule set.

After the rule optimization is performed on the service rule set, a service policy is generated based on the service rule set obtained after the rule optimization. After the service policy is generated, policy evaluation is performed on the generated service policy, and after the policy evaluation succeeds, the generated service policy is provided to the service party.

In addition, during service rule construction and service policy generation, visualization processing can further be performed, and a visualization processing result is presented to the service party.

FIG. 9 is an example block diagram of a service policy generation apparatus 900 according to Embodiment 2 of this specification. As shown in FIG. 9, the service policy generation apparatus 900 includes a data obtaining unit 910, a feature preprocessing unit 920, a rule training unit 930, a rule optimization unit 940, a policy generation unit 950, a policy evaluation unit 960, and a policy providing unit 970.

The data obtaining unit 910 is configured to obtain a service data sample set. Optionally, the data obtaining unit 910 can further obtain a specified service constraint. For an operation performed by the data obtaining unit 910, refer to the operation described above with reference to 510 in FIG. 5.

The feature preprocessing unit 920 is configured to perform feature preprocessing on the obtained service data sample set. For an operation performed by the feature preprocessing unit 920, refer to the operation described above with reference to 520 in FIG. 5.

The rule training unit 930 is configured to perform multi-objective optimization-based rule training based on the service data sample set obtained after the feature preprocessing and the specified service constraint, to construct a service rule set. For an operation performed by the rule training unit 930, refer to the operation described above with reference to 530 in FIG. 5.

The rule optimization unit 940 is configured to perform rule optimization on the constructed service rule set. For an operation performed by the rule optimization unit 940, refer to the operation described above with reference to 540 in FIG. 5.

The policy generation unit 950 is configured to generate a service policy based on the service rule set obtained after the rule optimization. For an operation performed by the policy generation unit 950, refer to the operation described above with reference to 550 in FIG. 5.

The policy evaluation unit 960 is configured to perform policy evaluation on the generated service policy. For an operation performed by the policy evaluation unit 960, refer to the operation described above with reference to 560 in FIG. 5.

The policy providing unit 970 is configured to provide the service policy whose policy evaluation succeeds to a service party. For an operation performed by the policy providing unit 970, refer to the operation described above with reference to 570 in FIG. 5.

In addition, it should be noted that in another embodiment, some components, for example, the feature preprocessing unit, the rule optimization unit, the policy evaluation unit, and the policy providing unit, in the service policy generation apparatus shown in FIG. 9 may not be included.

### Embodiment 3

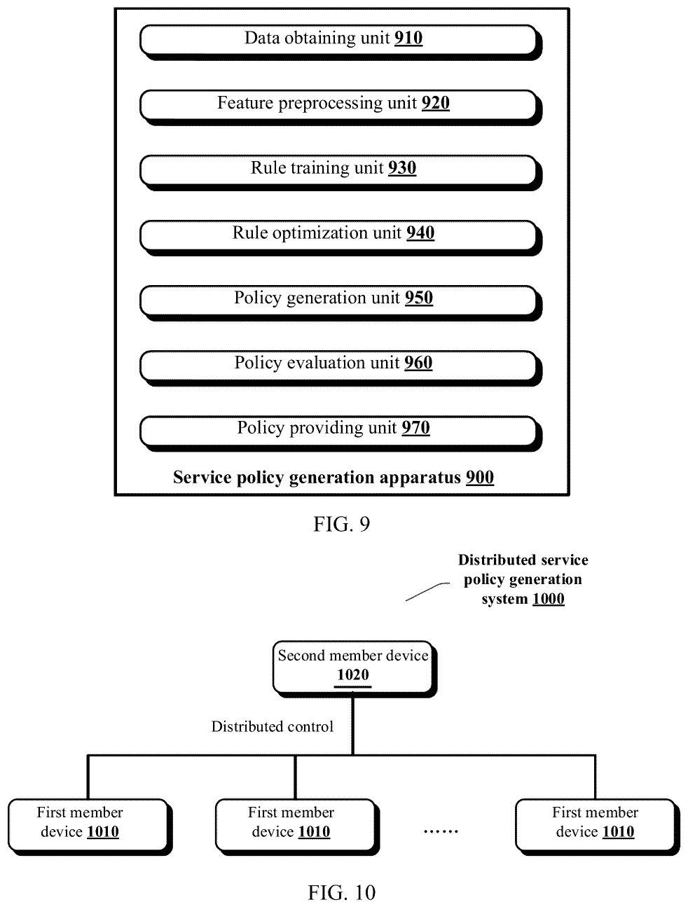

FIG. 10 is an example block diagram of a distributed service policy generation system 1000 according to Embodiment 3 of this specification.

As shown in FIG. 10, the distributed service policy generation system 1000 includes at least two first member devices 1010 and a second member device 1020. The service policy generation apparatus described above with reference to FIG. 4 or FIG. 9 is deployed on each first member device 1010.

The second member device 1020 is configured to schedule service data sample distribution between the first member devices. Optionally, in an example, a scheduling policy of the second member device 1020 is to balance loads on the first member devices and/or optimize communication costs between the second member device and each first member device. After receiving a service data sample distributed by the second member device 1020, each first member device 1010 generates a service policy according to the foregoing service policy generation method by using the service policy generation apparatus.

In some embodiments, the first member device and the second member device can be communicatively connected through a network, to perform data communication with each other. In some embodiments, the network can be any one or more of a wired network or a wireless network. Examples of the network can include but are not limited to a cable network, an optical fiber network, a telecommunication network, an enterprise intranet, the Internet, a local area network (LAN), a wide area network (WAN), a wireless local area network (WLAN), a metropolitan area network (MAN), a public switched telephone network (PSTN), a Bluetooth network, ZigBee (ZigBee), near field communication (NFC), an in-device bus, an in-device line, or any combination thereof. In some embodiments, the first member device and the second member device can be directly communicatively connected.

In this specification, the first member device and the second member device can be any appropriate electronic devices with a computing capability. Examples of the first member device and the second member device can include but are not limited to a personal computer, a server computer, a workstation, a desktop computer, a laptop computer, a notebook computer, a mobile electronic device, a smartphone, a tablet computer, a cellular phone, a personal digital assistant (PDA), a handheld apparatus, a message transceiver device, a wearable electronic device, a consumer electronic device, and the like.

According to the distributed service policy generation system, a large quantity of service data samples are distributed on a plurality of service policy generation apparatuses, to generate a service policy. In this way, service rule mining and service policy generation based on large-scale service data can be supported, for example, service rule mining based on big data of a magnitude higher than a billion can be supported.

The service policy generation method and the service policy generation apparatus according to the embodiment of this specification are described above with reference to FIG. 1 to FIG. 10. The service policy apparatus can be implemented by using hardware, or can be implemented by using software or a combination of hardware and software.

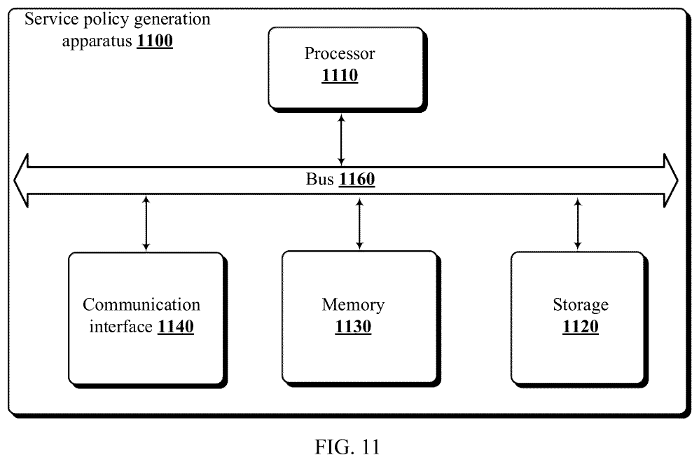

FIG. 11 is a schematic diagram of a service policy generation apparatus 1100 implemented based on a computer system according to an embodiment of this specification. As shown in FIG. 11, the service policy generation apparatus 1100 can include at least one processor 1110, a storage (for example, a nonvolatile storage) 1120, a memory 1130, and a communication interface 1140. The at least one processor 1110, the storage 1120, the memory 1130, and the communication interface 1140 are connected together by using a bus 1160. The at least one processor 1110 executes at least one computer-readable instruction (namely, the foregoing element implemented in a software form) stored or encoded in the storage.

In an embodiment, the storage stores computer-executable instructions. When the computer-executable instructions are executed, the at least one processor 1110 is enabled to perform the following operations: obtaining a service data sample set, where each service data sample in the service data sample set includes at least one service feature and at least two label values; performing multi-objective optimization-based service rule training based on the service data sample set, to construct a service rule set, where each optimization objective in multi-objective optimization corresponds to one label in the service data; and generating a service policy based on the service rule set.

It should be understood that when the computer-executable instructions stored in the storage are executed, the at least one processor 1110 is enabled to perform the operations and functions described above with reference to FIG. 1 to FIG. 9 in the embodiments of this specification.

According to an embodiment, a program product such as a machine-readable medium (for example, a non-temporary machine-readable medium) is provided. The machine-readable medium can have instructions (namely, the foregoing element implemented in a software form). When the instructions are executed by a machine, the machine is enabled to perform the operations and functions described above with reference to FIG. 1 to FIG. 9 in the embodiments of this specification. Specifically, a system or an apparatus in which a readable storage medium is disposed can be provided, and software program code for implementing a function in any one of the foregoing embodiments is stored in the readable storage medium, so that a computer or a processor of the system or the apparatus reads and executes instructions stored in the readable storage medium.

In this case, the program code read from the readable medium can implement the function in any one of the foregoing embodiments. Therefore, the machine-readable code and the readable storage medium that stores the machine-readable code form a part of this specification.

Embodiments of the readable storage medium include a floppy disk, a hard disk, a magneto-optical disc, an optical disc (for example, a CD-ROM, a CD-R, a CD-RW, a DVD-ROM, a DVD-RAM, a DVD-RW, and a DVD-RW), a magnetic tape, a nonvolatile storage card, and a ROM. Alternatively, program code can be downloaded from a server computer or cloud through a communication network.

According to an embodiment, a computer program product is provided. The computer program product includes a computer program. When the computer program is executed by a processor, the processor is enabled to perform the operations and functions described above with reference to FIG. 1 to FIG. 9 in the embodiments of this specification.

A person skilled in the art should understand that various variations and modifications to the embodiments disclosed above can be made without departing from the essence of this specification. Therefore, the protection scope of this specification shall be limited by the appended claims.

It should be noted that not all the steps and units in the foregoing procedures and system structural diagrams are required, and some steps or units can be ignored based on an actual requirement. An execution sequence of the steps is not fixed, and can be determined based on a requirement. The apparatus structure described in the foregoing embodiments can be a physical structure, or can be a logical structure, that is, some units may be implemented by a same physical entity, or some units can be implemented by a plurality of physical entities, or can be jointly implemented by some components in a plurality of independent devices.

In the foregoing embodiments, the hardware unit or the module can be implemented in a mechanical form or an electrical form. For example, the hardware unit, the module, or the processor can include a permanent dedicated circuit or logic (for example, a dedicated processor, an FPGA, or an ASIC) to complete a corresponding operation. The hardware unit or the processor can further include a programmable logic or circuit (for example, a general-purpose processor or another programmable processor), and can be temporarily set by software to complete a corresponding operation. A specific implementation (a mechanical form, a dedicated permanent circuit, or a circuit that is temporarily set) can be determined based on cost and time considerations.

The example embodiments are described above with reference to the specific implementations described in the accompanying drawings, but do not represent all embodiments that can be implemented or fall within the protection scope of the claims. The term “example” used throughout this specification means “used as an example, an instance, or an illustration”, and does not mean “preferred” or “advantageous” over other embodiments. For the purpose of providing an understanding of the described technology, the specific implementations include specific details. However, these techniques can be implemented without these specific details. In some instances, well-known structures and apparatuses are shown in block diagram forms, to avoid difficulty in understanding the concept in the described embodiments.

The foregoing descriptions of this disclosure are provided to enable any person of ordinary skill in the art to implement or use this disclosure. It is clear to a person of ordinary skill in the art that various modifications are made to this disclosure. In addition, the general principle defined in this specification can be applied to another variant without departing from the protection scope of this disclosure. Therefore, this disclosure is not limited to the examples and designs described in this specification, but is consistent with the widest range that conforms to principles and novel features disclosed in this specification.

1. A service policy generation method, comprising:
obtaining a service data sample set, wherein each service data sample in the service data sample set comprises at least one service feature and at least two labels;
performing multi-objective optimization-based service rule training based on the service data sample set, to construct a service rule set, wherein each optimization objective in multi-objective optimization corresponds to one label in the service data sample; and
generating a service policy based on the service rule set.

2. The service policy generation method according to claim 1, wherein the performing multi-objective optimization-based service rule training based on the service data sample set, to construct a service rule set comprises:
performing multi-objective optimization-based service rule training based on the service data sample set by using a sequential covering algorithm, to construct the service rule set.

3. The service policy generation method according to claim 1, wherein an evaluation indicator used for the multi-objective optimization is determined based on optimization objectives corresponding to the labels in the service data sample.

4. The service policy generation method according to claim 3, wherein the at least two labels comprise a black sample label and a capital loss label, and the optimization objectives comprise a black sample hit precision rate corresponding to the black sample label and a capital loss recall rate corresponding to the capital loss label.

5. The service policy generation method according to claim 4, wherein the evaluation indicator node_score is determined based on the following formula:
$$nod\_score = ( 1 + {β}^{2} ) * \frac{precision * {recall}_{captial \_ loss}}{{β}^{2} * precision + {recall}_{captial \_ loss}} ,$$
wherein
precision represents the black sample hit precision rate, recall_{captial_loss} represents the capital loss recall rate, and β is a hyper-parameter used to adjust weights of two optimization objectives.

6. The service policy generation method according to claim 1, wherein the service data sample set used for the service rule training is a service data sample set obtained after feature selection processing.

7. The service policy generation method according to claim 1, further comprising:
performing feature preprocessing on the obtained service data sample set before the service rule set is constructed.

8. The service policy generation method according to claim 7, wherein the feature preprocessing comprises at least one of the following preprocessing: feature selection processing, monotonicity constraint processing, and feature physical meaning constraint processing.

9. The service policy generation method according to claim 1, further comprising:
performing rule optimization on the constructed service rule set.

10. The service policy generation method according to claim 9, wherein the rule optimization comprises at least one of the following optimization processing: rule deduplication, specific service constraint-based rule filtering, reverse rule supplementation, visualization-based manual filtering, and custom indicator-based rule filtering.

11. The service policy generation method according to claim 1, wherein the generating a service policy based on the service rule set comprises:
generating the service policy based on the service rule set by using a greedy algorithm.

12. The service policy generation method according to claim 1, further comprising:
performing inverted tree result visualization processing on the generated service policy; and
providing a visual evaluation report to a service party during service generation or policy generation.

13. The service policy generation method according to claim 1, further comprising:
performing policy evaluation on the generated service policy; and
providing the service policy whose policy evaluation succeeds to a service party.

14. The service policy generation method according to claim 1, wherein the obtaining a service data sample set comprises: obtaining the service data sample set and a specified service constraint; and
the performing multi-objective optimization-based service rule training based on the service data sample set, to construct a service rule set comprises: performing multi-objective optimization-based service rule training based on the service data sample set and the specified service constraint, to construct the service rule set.

15. (canceled)

16. (canceled)

17. (canceled)

18. (canceled)

19. (canceled)

20. (canceled)

21. (canceled)

22. A computing device comprising a memory and a processor, wherein the memory stores executable instructions that, in response to execution by the processor, cause the processor to:
obtain a service data sample set, wherein each service data sample in the service data sample set comprises at least one service feature and at least two labels;
perform multi-objective optimization-based service rule training based on the service data sample set, to construct a service rule set, wherein each optimization objective in multi-objective optimization corresponds to one label in the service data sample; and
generate a service policy based on the service rule set.

23. A non-transitory computer-readable storage medium, comprising instructions stored therein that, when executed by a processor of a computing device, cause the processor to:
obtain a service data sample set, wherein each service data sample in the service data sample set comprises at least one service feature and at least two labels;
perform multi-objective optimization-based service rule training based on the service data sample set, to construct a service rule set, wherein each optimization objective in multi-objective optimization corresponds to one label in the service data sample; and
generate a service policy based on the service rule set.

24. (canceled)
